(19) United States
(12) Patent Application Publication
(10) Pub. No.: US 2005/0230003 A1
(43) Pub. Date: Oct. 20, 2005

(54) Router table and accessories

(76) Inventor: Uwe Radermacher, Weibern (DE)

Correspondence Address: Michael S. Leonard;EVEREST INTELLECTUAL PROPERTY LAW GROUP, P.O. Box 708, Northbrook, IL, 60065, US

(21) Appl. No.: 11/073,318

(22) Filed: Mar. 3, 2005

(30) Foreign Application Priority Data
Mar. 5, 2004 (DE) 102004010735.1
Feb. 25, 2005 (DE) 102005009227.6

(51) Int. Cl. F16B 1/00; E04G 3/00; G09F 7/18; A47B 96/06; B25H 1/00

(52) U.S. Cl. 144/286.5

(57) ABSTRACT

A router table (1) with a worktop (2) which has an opening (22) for the passage of a router bit which is drivable by a drive machine (12) which is mountable on an underside (4) of the worktop (2). A mounting flange (13) of the drive machine is laterally fixable in position by centering elements (28) disposed on the underside (4) of the worktop (2), and is clampable against the underside (4, 15) by claws (26). The claws (26) are in each case mounted on the worktop (2) by a clamping pin (27). The centering elements are centering disks (28) with eccentric openings (29) through which the clamping pin (27) protrudes in each case.

### CROSS-REFERENCE TO RELATED APPLICATIONS

This patent application claims priority of German patent application no. 102004010735.1, filed Mar. 5, 2004 and German patent application no. unknown, filed Feb. 25, 2005, both of which are incorporated herein by reference.

### BACKGROUND OF THE INVENTION

The invention relates in the first instance to a router table with a worktop which has an opening for the passage of the router bit which is drivable by a drive machine, in particular in the form of a routing machine, which is mountable on the underside of the worktop, a mounting flange of the drive machine being laterally fixable in position by means of centering elements disposed on the underside of the worktop, and being clampable against the underside by means of claws, which claws are in each case mounted on the worktop by means of a clamping pin.

Router tables of this type are known from U.S. Pat. No. 6,360,798.

A router table has a worktop. There is an opening in the worktop. A drive machine is located on the underside of the worktop. The drive machine has a drive shaft. A chuck is seated on the drive shaft. A router bit, for example an end router bit, is held in the chuck. The said end router bit protrudes through the opening in the worktop. In addition, the underside of the worktop can be provided with a supporting frame, for example with supporting legs. A stop against which the workpiece can be guided is located on the top side of the worktop. The said stop, which is displaceable in a horizontal direction in a manner guided on the worktop and is fixable in the displacement positions, is also referred to as a parallel stop. The worktop may also have a guide which runs transversely thereto, i.e. parallel to the stop, and in which a further stop can be located. Spring elements, as are known, for example, from U.S. 2002/0,162,439 A1, can be mounted on the parallel stop. These spring elements serve to hold down the workpiece against the worktop. A T-groove can be provided on the parallel stop, in which groove is located a sliding block, with the aid of which the spring element can be mounted on the parallel stop. However, the spring element may also be disposed in the further guide groove of the worktop, which guide groove I is likewise formed, if appropriate, as a T-groove, in order, by means of its spring force, to produce an action pressing the workpiece against the parallel stop.

The drive machine, which is mounted on the underside of the worktop, may be a routing machine. This routing machine has a mounting flange which has an outline contour which is substantially circular or is similar to a circular shape. The end surface of this mounting flange is pressed against the underside of the worktop or against the base of a recess on the underside of the worktop. Clamping claws are used for this. The lateral position is fixed by means of centering elements. The latter engage at three or four peripheral points on the mounting flange. In the mounted position, the mounting flange is in touching engagement on this centering element.

### SUMMARY OF THE INVENTION

The invention relates to router tables and accessories for router tables in a manner advantageous for use.

Claim 1 makes provision for the centering element to be a centering disk with an eccentric opening. The clamping pin carrying a claw protrudes through the opening. The underside of the centering disk can be at a slight spacing from the underside of the worktop. A direct engagement of the centering disk on the underside of the worktop is preferably provided only on the immediate region surrounding the eccentric opening. The centering disk may have a circular outline contour. A nut may be disposed within the centering disk, so that the centering disk can be screwed to the clamping pin, which can have an external thread. The centering disk may be mounted on the clamping pin with a nut with a lock nut effect being formed. However, it is also possible for the clamping pin to be located rotatably in an opening in the worktop, so that the clamping action can be obtained by rotation of the clamping pin. The centering disk then serves not only to laterally fix the drive machine in position, but also to fix the clamping pin against rotation. The clamping claw may be a plastics part. A thrust component may act on a corrugated thrust flank which has a longitudinal slot through which the clamping pin protrudes. A knurled nut or wing nut which is screwed onto the clamping pin may act on this thrust component. The claw is supported on the base of the depression or on the underside of the worktop with an, in particular, circular cylindrical supporting shoulder. The other arm of the claw presses onto the mounting flange of the drive machine. An alternative variant makes provision for the clamping pin to be in plug-connection with the retaining plate. For this purpose, it has a conical end portion which is located in a corresponding countersink of the retaining plate. The countersink may be produced by bending and has a lateral recess into which a nose, which protrudes out of the conical surface of the end portion of the clamping pin, can enter for the purpose of securing against rotation.

Mounting of the clamping pin on the worktop is of independent importance. The top side of the worktop may have cup-like depressions in which plate-like retaining disks are located. The rear side of the retaining disks have a threaded flange. The threaded flange protrudes into a through hole. The clamping pin is screwed into the threaded flange.

The invention furthermore relates to a router table with a worktop and a longitudinal stop, which is disposed on the worktop and has a stop jaw carrier which is displaceable in a first horizontal direction, guided on the worktop, which stop jaw carrier has two stop jaws, which are displaceable toward each other and are clampable in the displacement positions, with a T-shaped guide groove, which is aligned in a second horizontal direction, for receiving a sliding block on which a spring element, which acts perpendicularly to the plane of extent of the worktop, is mountable.

The stop jaws are mounted releasably on the stop jaw carrier. Mounting means, in particular in the form of a clamping screw and a clamping nut screwed onto the clamping screw, are used for this. When the clamping screw/nut is released, the stop jaw can be displaced in the horizontal direction along a supporting surface of the stop jaw carrier. The two clamping jaws can therefore be displaced toward each other. As a consequence of this displacement possibility, the spacing between the two clamping jaws can be set to the diameter of the particular router bit. The router bit is located in the intermediate space between the two stop jaws.

The invention makes provision for the walls of the guide groove which serve to receive the sliding block to be formed, on the one hand, by the stop jaw carrier and, on the other hand, by the stop jaw. For this purpose, the supporting surface of the stop jaw carrier, on which the stop jaw is displaceable in the horizontal direction and on which it rests in a manner such that can be fixed against the possibility of being displaced, can be configured in the shape of an L. The L-leg here forms the one, likewise L-shaped, wall of the T-groove. The wall lying opposite this wall is formed by a narrow longitudinal edge of the stop jaw. The sliding block which carries the spring element is located in this T-groove.

The invention furthermore relates to a spring element for a router table or the like, as previously known, in particular, from U.S. 2002/0,162,439 A1. The spring element previously disclosed there is complex. It has a plurality of spring webs disposed in the manner of a comb.

According to the invention, the spring element has a peripherally continuous leaf spring. This leaf spring may have a substantially elliptical form, the large semiaxis of the ellipse preferably being more than twice the length of the small semiaxis of the ellipse. The spring element having the leaf spring may consist of plastics. The spring element furthermore has a carrying element. The latter has a longitudinal slot. The shank of a clamping screw or a clamping pin which interacts with the sliding block can protrude through the longitudinal slot. The leaf spring is preferably mounted as a unitary component on the carrying element. The spring element configured in this manner may be manufactured as an injection molded part. The carrying element is preferably molded on in the region of the small semiaxis of the ellipse of the leaf spring. The longitudinal slot may then be located as an aligned extension of the small semiaxis. A step provided in the region of the narrow ends of the elliptical spring serves as adjusting aid. The vertical position of the spring element to the worktop or the spacing of the spring element from the parallel stop may be adjusted with the aid of this step. It is adjusted to the thickness or width of the workpiece. Since the gently curved convexity of the leaf spring protrudes over this stop surface, the leaf spring is stretched, shortening the small semiaxis, when the workpiece is displaced. The step may be formed by a kink in this spring. However, it is also possible to form the step from a hump.

In a development of the invention, which has independent importance, it is provided that a reinforcing plate made of metal is located on the base of the depression. Since the thickness of the material of the worktop in the region of the depression is reduced, this reinforcing plate serves to increase stability. On account of the reduced material thickness, the reinforcing plate is secured at the edge of the depression. For this purpose, the reinforcing plate which embodies substantially the shape of a four-leafed clover provides securing tongues. Preferably two diametrically opposed securing tongues are provided, which project from the edge of the reinforcing plate with the formation of a right angle. The reinforcing plate is screwed to a portion of the edge of the depression by means of the portions of the plate projecting over the edge.

Additional features and advantages of the present invention are described in, and will be apparent from, the following Detailed Description of the Invention and the figures. The features and advantages may be desired, but, are not necessarily required to practice the present invention.

### BRIEF DESCRIPTION OF THE FIGURES

Exemplary embodiments of the invention are explained with reference to accompanying drawings.

FIG. 1 shows the front view of a router table.

FIG. 2 shows a plan view of the router table according to FIG. 1.

FIG. 3 shows a bottom view in perspective.

FIG. 4 shows a bottom view of the router table according to FIG. 1.

FIG. 5 shows a section along the line V-V in FIG. 1, illustrated on an enlarged scale.

FIG. 6 shows a section along the line VI-VI in FIG. 4, illustrated on an enlarged scale.

FIG. 7 shows the front view of a spring element.

FIG. 8 shows a further exemplary embodiment of a spring element.

FIG. 9 shows, in an illustration corresponding to FIG. 4, a further exemplary embodiment of the invention.

FIG. 10 shows, in an illustration corresponding to FIG. 6, the exemplary embodiment according to FIG. 9.

FIG. 11 shows a perspective, exploded illustration of the clamping element of the exemplary embodiment of FIGS. 9 and 10.

FIG. 12 shows in plan view a reinforcing plate which can be introduced into the depression.

FIG. 13 shows the reinforcing plate according to FIG. 12 in side view.

FIG. 14 shows an enlarged portion according to XIV in FIG. 13.

FIG. 15 shows a perspective representation of the reinforcing plate.

FIG. 16 shows a bottom view of a routing table substantially in accordance with FIG. 3 having a reinforcing plate set into the depression.

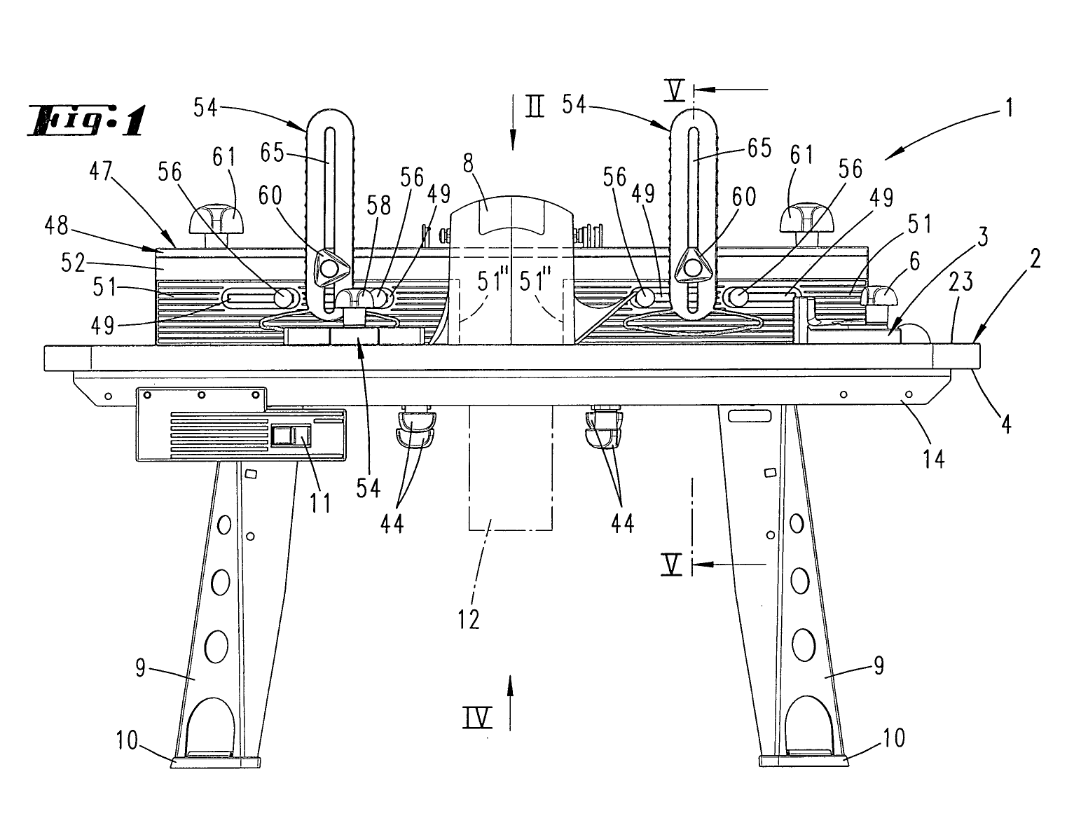

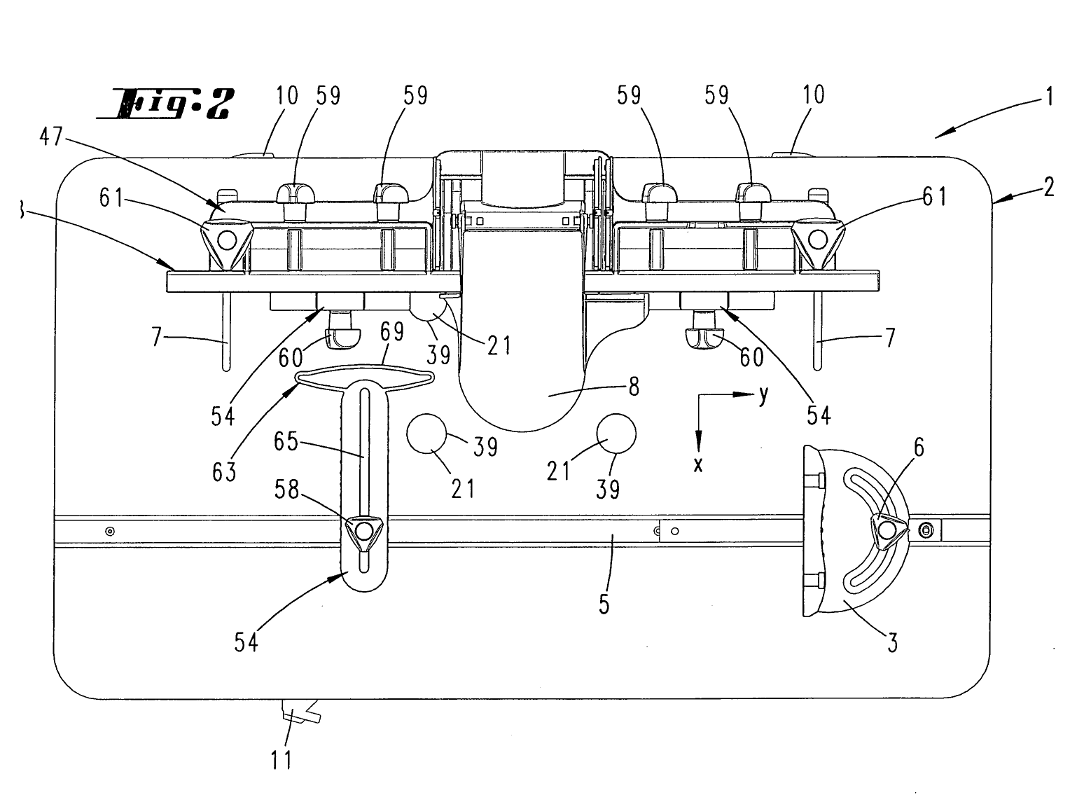

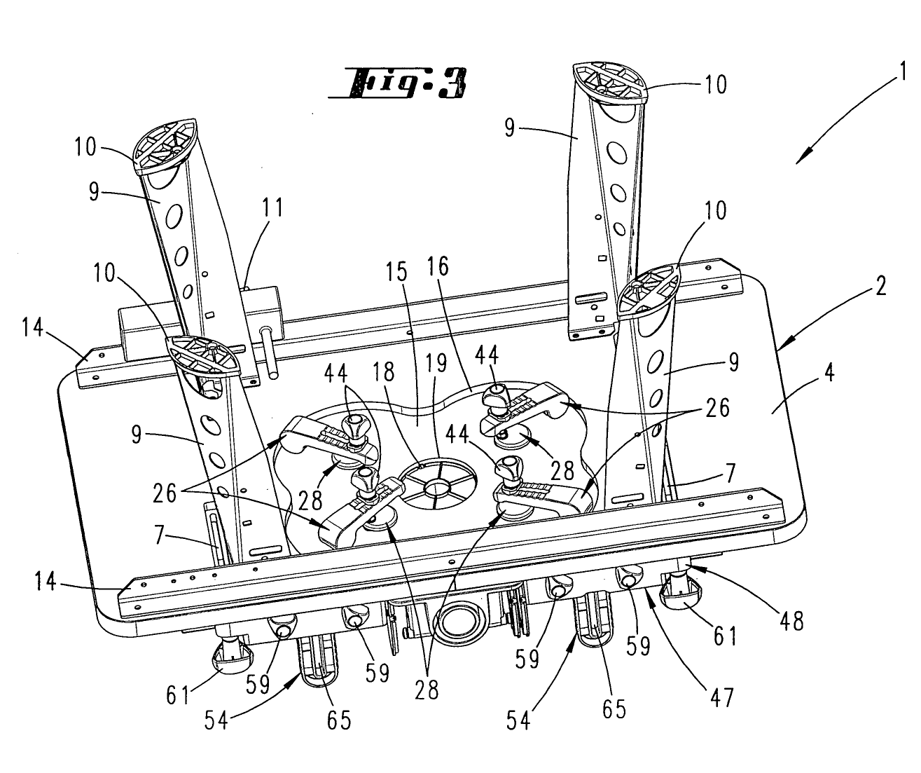

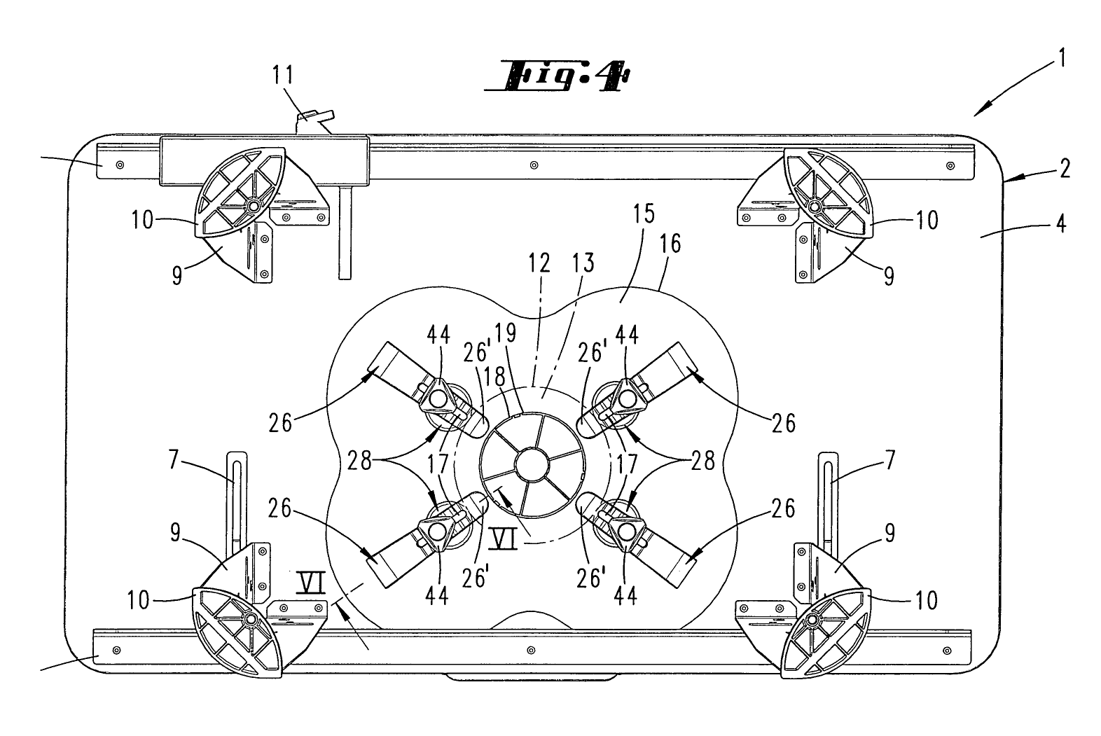

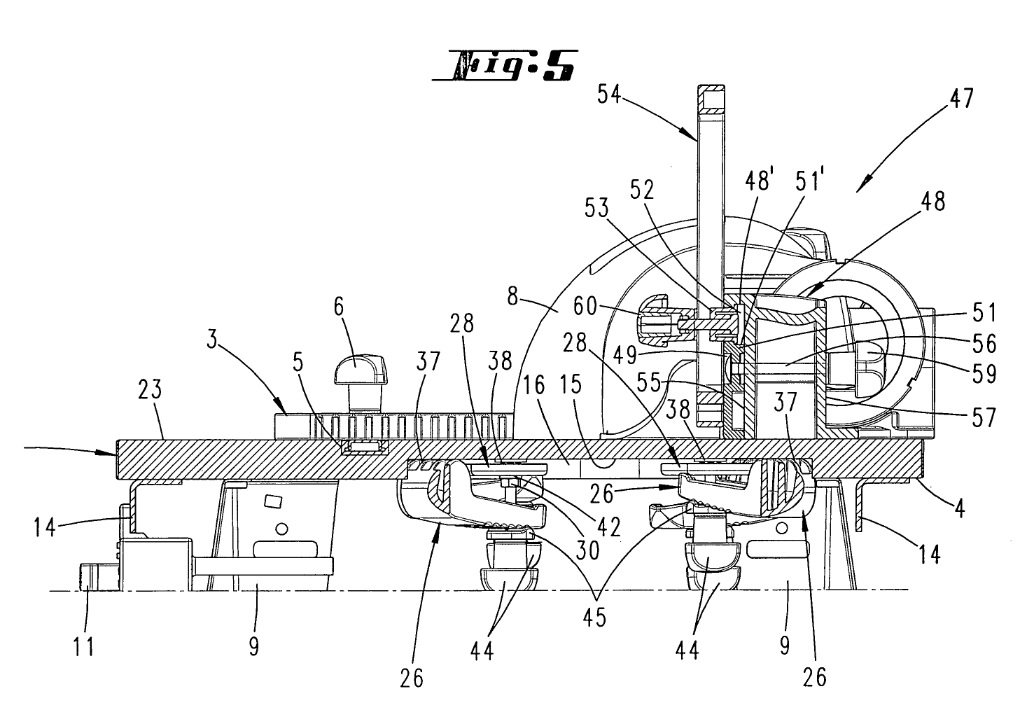

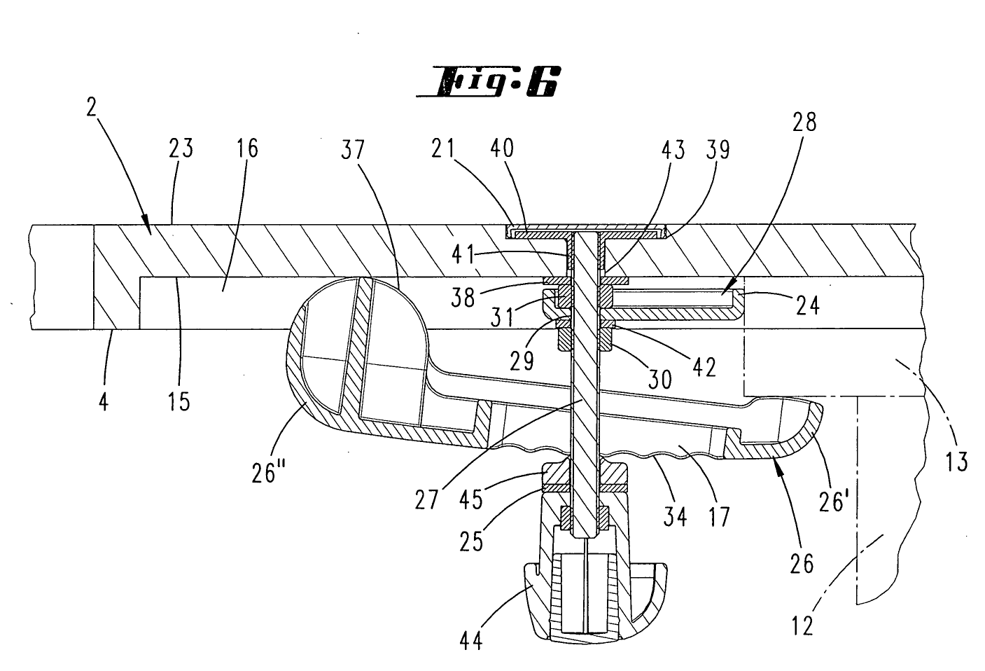

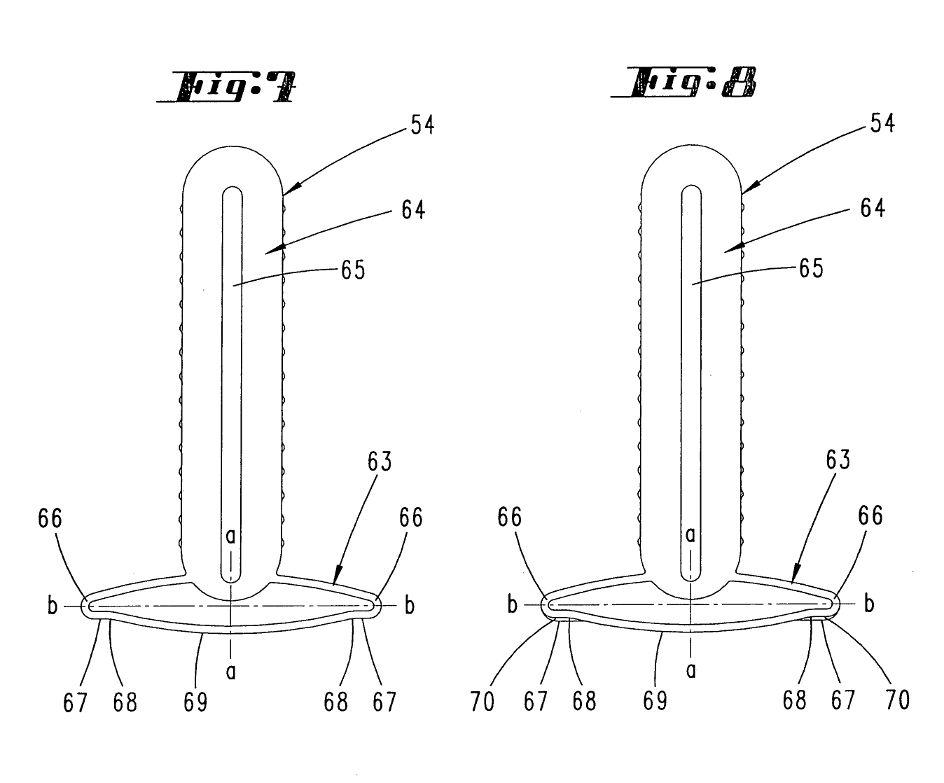

### DETAILED DESCRIPTION OF THE INVENTION

The invention relates to a router table 1. The latter has a horizontal worktop 2. Legs 9 which are obliquely L-shaped protrude from the underside 4 of the worktop 2 and their free ends are provided with a respective rubber foot cap 10. At its two longitudinal edge sides, the underside 4 has a respective angled rail 14 serving for stabilization purposes. In addition, a housing 11 for a switch is located on the front angled rail 14.

A depression 16 which forms a base 15 running parallel to the underside 4 is located in the center of the underside 4. As a consequence of this depression 16, the material thickness of the worktop 2 is reduced in the central region.

A circular opening 22 is located approximately in the center of the depression 16, which has a rounded wall. In the exemplary embodiments, a reducing component 18 is placed in the opening 22, the edge of which reducing component rests on a step 19 in such a manner that the surface of the reducing component 18 is aligned with the top side 23 of the worktop 2. In the center, the reducing component 18, which has a circular outline, has an opening 20 through which a routing bit can protrude above the top side 23.

The router bit (not illustrated in the figures) belongs to a routing machine 12 which is mountable on the base 15 of the depression 16.

The routing machine 12, which is illustrated merely by chain-dotted lines in the figures, has a mounting flange 13 (likewise merely illustrated by chain-dotted lines in the drawings) at its router bit end. This mounting flange 13 may have a substantially circular outline.

In order to fix the mounting flange 13 laterally in position in such a manner that the routing bit protrudes through the opening 20, centering disks 28 are provided. A total of four centering disks 28 are located on the base 15 of the depression 16.

The centering disks 28 have a cup-shaped form. They are circular and have an eccentric opening 29.

A total of four shallow depressions 39 are placed in the top side 23 of the worktop 2. A retaining plate 40 consisting, in particular, of metal is situated on the base of each depression 39. In the exemplary embodiment illustrated in FIG. 6, the retaining plate 40 has a threaded flange 41 at the back. A threaded pin 27 is screwed into this threaded flange 41. The said threaded pin forms a clamping pin. For the rotationally secure connection of the clamping pin 27 to the retaining plate 40 now associated with it, the portion screwed into the threaded flange 41 may also be bonded there.

The retaining plate 40 is covered by a plastics cap 21, the top side of which is flush with the top side 23 of the worktop 2.

By means of a nut 31 with a washer 38 put underneath it, the retaining plate 40 is braced against the base of the depression 39, so that it is rotationally fixed with respect to the worktop 2.

The clamping pin 27 protrudes through the eccentric opening 29 in the centering disk 28 which rests directly on the nut 31. With the interposition of a further washer 42, a clamping nut 30 acts against the centering disk 28. When the clamping nut 30 is released, the centering disk 28 can be pivoted about the clamping pin 27. Tightening the clamping nut 30 enables the pivot position of the centering disk 28 to be fixed with respect to the clamping pin 27.

A wing nut 44 is screwed onto the free end of the clamping pin 27. An intermediate portion of the clamping pin 27 reaches through a longitudinal slot 17 of a clamping claw 26. The back of the clamping claw 26 that faces the wing nut 44 forms a corrugated thrust flank 34. A thrust component 45, through which the clamping pin 27 reaches, is supported on this corrugated thrust flank 24, with the wing nut 44, with the interposition of a further washer 25, acting against the said thrust component.

The clamping pin 27 is therefore simultaneously the bearing pin of the centering disk 28 and of the clamping claw 26.

An end portion 26′ of the clamping claw 26 presses onto the mounting flange 13 of the routing machine 12. The other end portion 26″ of the clamping claw 26 forms a rounded supporting shoulder 37 which is supported on the base 15 of the depression 16. The longitudinal slot 17, through which the clamping pin 27 reaches, of the clamping claw 26 is located between the two ends 26′, 26″ of the clamping claw 26 in a manner somewhat offset eccentrically with respect to the end 26′. The clamping claw 26, like the wing nut 44, is manufactured from plastics.

The manner in which the underside mounting with the centering device for the routing machine 12 operates is as follows.

When the wing nut 44 and clamping nut 30 are released, the routing machine is disposed laterally on the base 15 of the depression 16 in such a manner that its axis is located in the center of the opening 20. This takes place preferably with the routing table 1 upside down. The centering disks 28 are then pivoted until their respective peripheral edge 24 comes into engagement against the corresponding peripheral edge of the mounting flange 13. Since the centering disk 28 is at a slight spacing from the base 15, any chips lying on the base 15 do not have a negative effect.

The rotational position of the centering disks 28 is then fixed by the clamping nuts 30 being tightened. The mounting flange 13 is then mounted against the underside 15 of the depression 16 by means of the clamping claws 26 in a known manner, with the respective end portions 26′ being supported on the mounting flange 13.

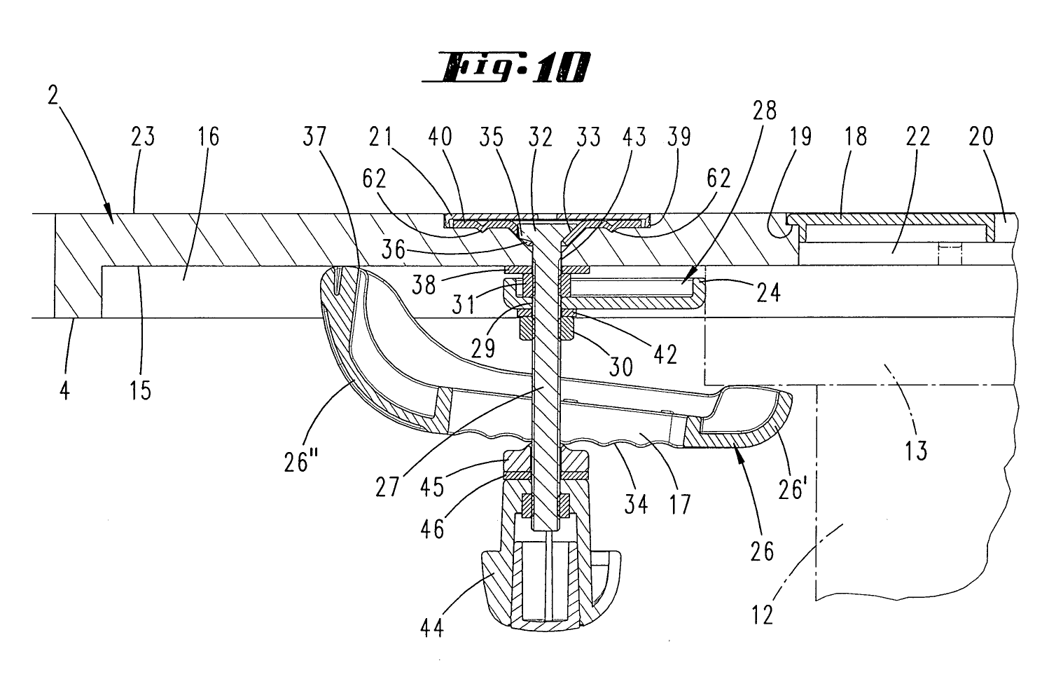

In the exemplary embodiment illustrated in FIG. 6, the rounded supporting shoulder 37 extends along a curve of an arc of a circle. In the exemplary embodiment illustrated in FIG. 10, the supporting shoulder 37 is configured to be solid in the end region.

In the exemplary embodiment illustrated in FIG. 10, the retaining plate 40 has pointed projections 62 which can dig into the base of the depression 39 in order to fix the retaining disk 40 against rotation. In the center, the retaining disk 40 has a countersink 33 formed by stamping. A conical end portion 32 of the clamping pin 27 is mounted in the countersink 33. A nose 35 protrudes laterally from the conical end portion 32 of the clamping pin 27. This nose 35 engages in a recess 36 of the countersink 33, so that the clamping pin 27 is secured against rotation. Otherwise, the clamping pin, as also in the exemplary embodiment illustrated in FIG. 6, is held against the worktop 2 by a nut 31.

A guide slot 5 extending in the longitudinal direction (Y-direction) is located on the top side 23 of the worktop 2. This guide slot 5 has a T-shaped profile. A sliding block, which is associated with an angled stop 3, can slide in it. The angled stop 3 can be fixed in its angular position by means of a clamping nut 6. It can be displaced in the Y-direction within the guide slot 5.

A clamping nut 58 also secures a spring element 54, which is described further on, in the guide slot 5. The clamping nut 58 fixes the spring element 54 both in the X- and in the Y-direction.

Furthermore, two guide grooves 7 extending in the X-direction are located in the top side 23 of the worktop 2. The guide grooves 7 are at a spacing from each other. Sliding blocks which interact with clamping nuts 61 are also mounted in these guide grooves 7. A stop jaw carrier 48 can be fixed in position by the clamping nuts 61 being tightened. When the clamping nuts 61 are released, the stop jaw carrier 48 can be displaced in the X-direction. Its spacing from the routing bit can be adjusted as a result.

The stop jaw carrier 48 forms a supporting surface 55 running substantially perpendicularly to the top side 23. Two stop jaws 51 are mounted on this supporting surface 55. The stop jaws 51 may be displaced toward each other in the direction Y. For this purpose, a pull component 56, which is formed as a mushroom head bolt, reaches through a longitudinal slot 49. This enables the spacing between the two facing narrow edges 51″ of the stop jaws 51 to be adjusted to the diameter of the routing bit (not illustrated). The routing bit is located between the two stop jaws 51 below a finger protector 8.

A clamping nut 59 which is screwed onto the pull component 56 is located on the rear side 57 of the stop jaw carrier 48. The position of the stop jaw 51 can be fixed by means of the clamping nut 59. The longitudinal narrow edges 51′ of the stop jaw 51 have an L-shaped form. An L-shaped portion 48′ of the stop jaw carrier is located opposite on the inside. The L-shaped portion 48′ and the narrow edge 51′ together form a T-shaped guide groove 52 for a sliding block 53. A spring element 54 is fixed on this sliding block 53. This also takes place by means of a clamping nut 60.

The abovementioned spring elements 54 form, on the one hand, a holding-down device which presses the workpiece against the top side 23 of the worktop 2 and, on the other hand, a horizontal thrust component which presses the workpiece against the stop jaw carrier 48 or stop jaws 51. The spring elements 54 have the form described below: the spring element 54 consists of a plastics part. It has an elongate carrying element 64 which has a longitudinal slot 65. The spring element 54 is mounted on the worktop 2 or on the stop jaw carrier 48 with the aid of the slot 65. For this purpose, a clamping screw or the like reaches through the slot 65.

An elliptical leaf spring 63 is molded on at one end of the carrying element 64. The convexity 69, which lies opposite the narrow end of the carrying element 64, forms the thrust surface which presses the spring element 64 against the workpiece. The convexity 69 has a large radius. The two narrow ends of the leaf spring 66 have a small radius.

To fix the spring element 54 in position, steps 67 are provided in the region of the narrow ends 66 and can be placed onto the top side of the edge of the workpiece. By this means, the spring deflecting travel of the thrust surface 69 is then defined.

The step 67 can be formed by a kink 68 in the end portion of the leaf spring 63. However, it is also provided that in this region the leaf spring 63 forms a step 67 which can be placed onto the top side of the workpiece.

If the workpiece is then pushed past the convexity 69 of the leaf spring 63, the convexity 69 can deflect in the direction of the carrying element 64. The elasticity of the leaf spring 63 then ensures the required contact pressure, on the one hand, against the top side 23 of the worktop 2, and the other hand, against the stop jaw 51.

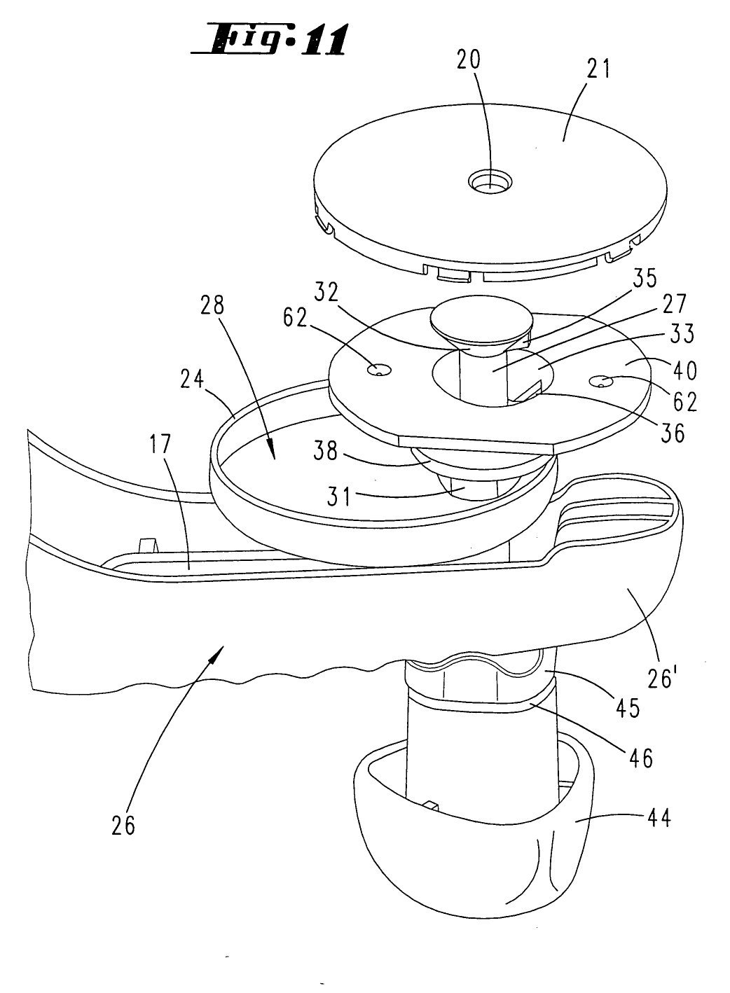

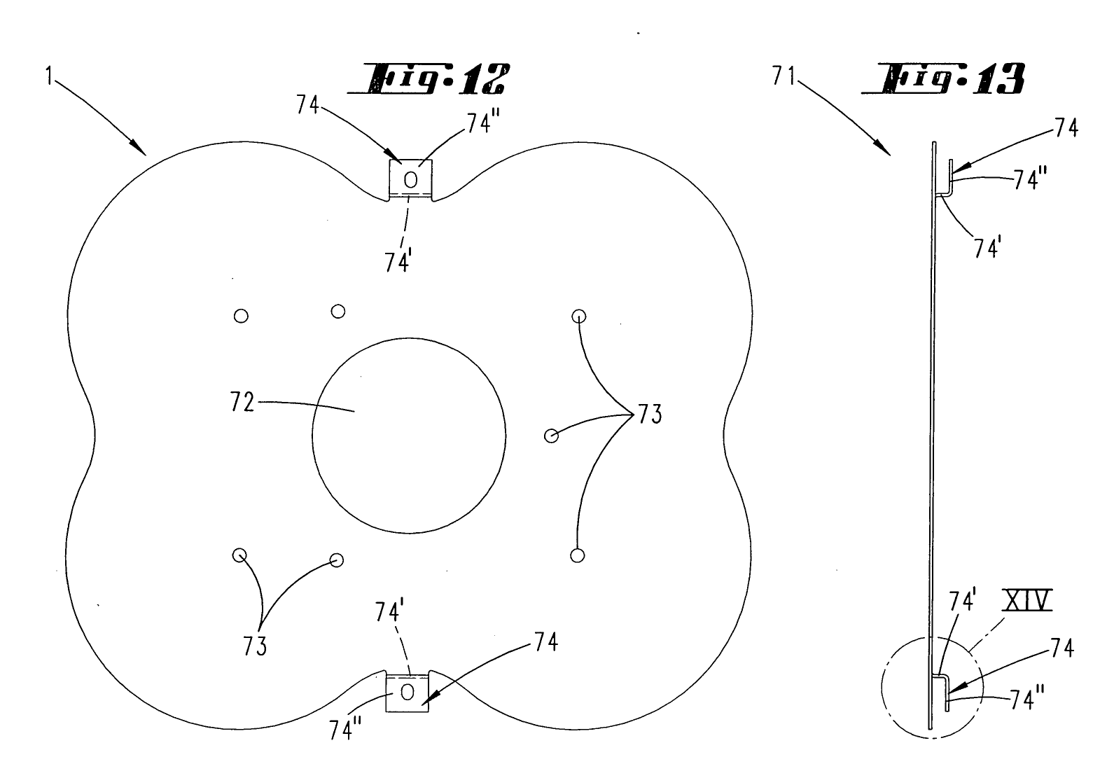

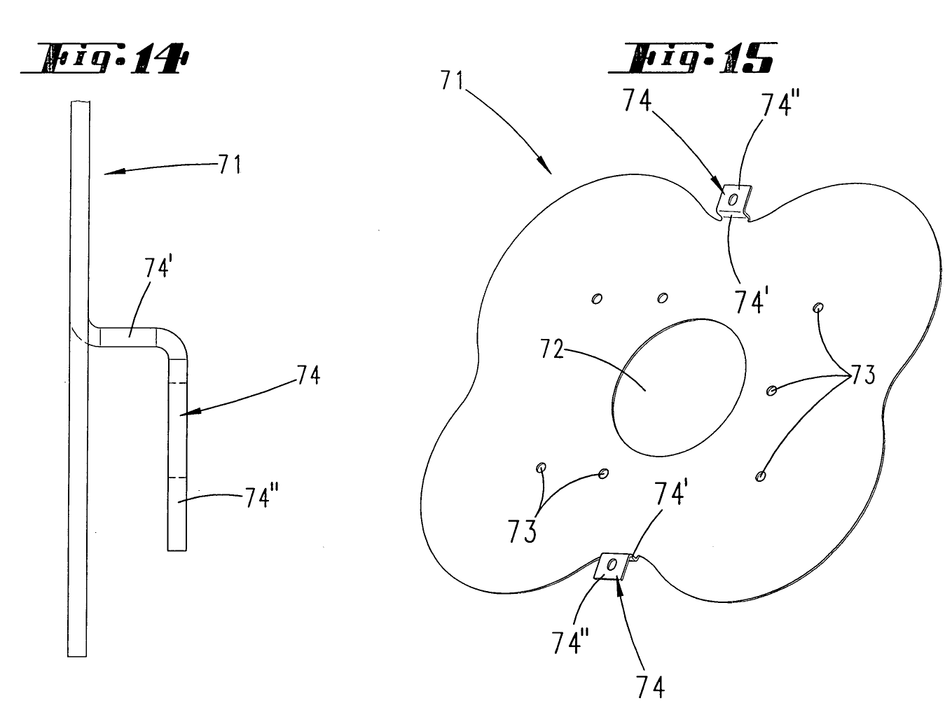

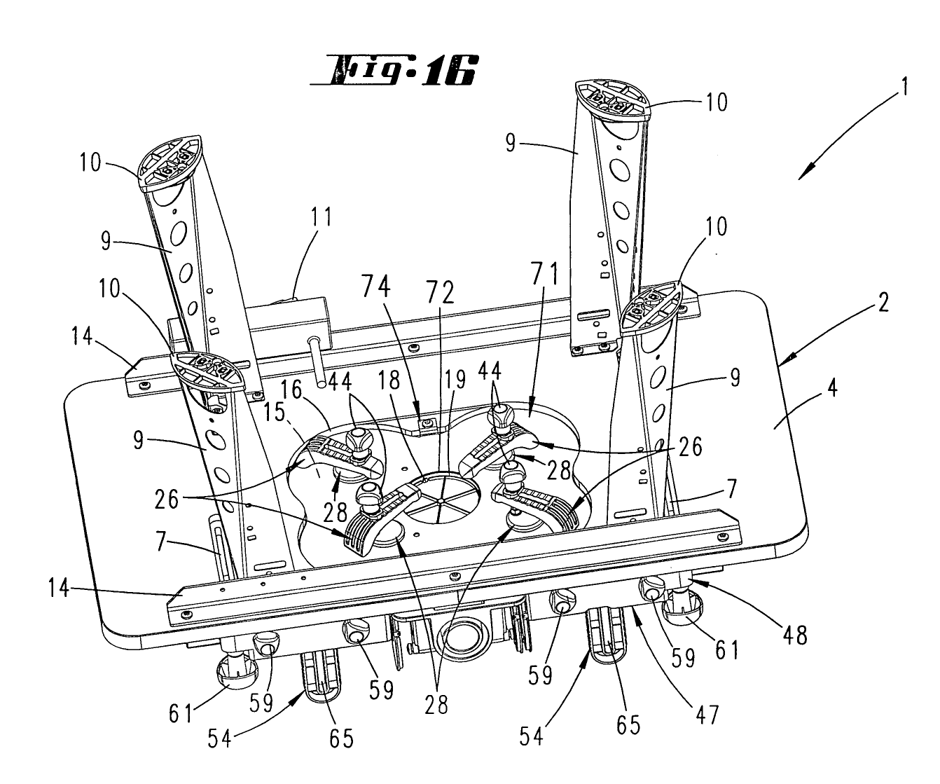

FIG. 12 shows a reinforcing plate 71 which can be inserted into the depression 16 of the underside 4 of the worktop 2. The reinforcing plate 71 has a peripheral contour which is substantially in the shape of a clover leaf, and it consists of steel and has at its centre an opening 72 which is congruent with the opening of the worktop 2 which accommodates the reducing component 18. Furthermore, securing openings 73 are located in the reinforcing plate 21 which are suitable for the passage of the threaded pins 27.

The outline contour of the reinforcing plate 71 corresponds to the outline contour of the depression 16 which accommodates it, so that the reinforcing plate 71 can be laid onto the base 15 of the depression 16. In this way, the base 15 which lacks material as compared with the remainder of the worktop 2 can be strengthened. Securing the reinforcing plate 71 is effected preferably to the edge of the underside 4 surrounding the depression 16. For this purpose, securing tongues 74 which project substantially at right angles are provide on the reinforcing plate 71. In the exemplary embodiment, the reinforcing plate 71 has in each case in the region of two opposed neck portions a securing tongue 74. The leg 74′ of the securing tongue 74 projecting directly from the edge of the reinforcing plate 71 has a length which corresponds to the depth of the depression 16. The securing leg 74″ projecting at right angles from this leg 74′ has a securing opening through which a fastening screw can be screwed, by means of which screw this securing tongue 74 can be fastened to the edge region of the depression 16.

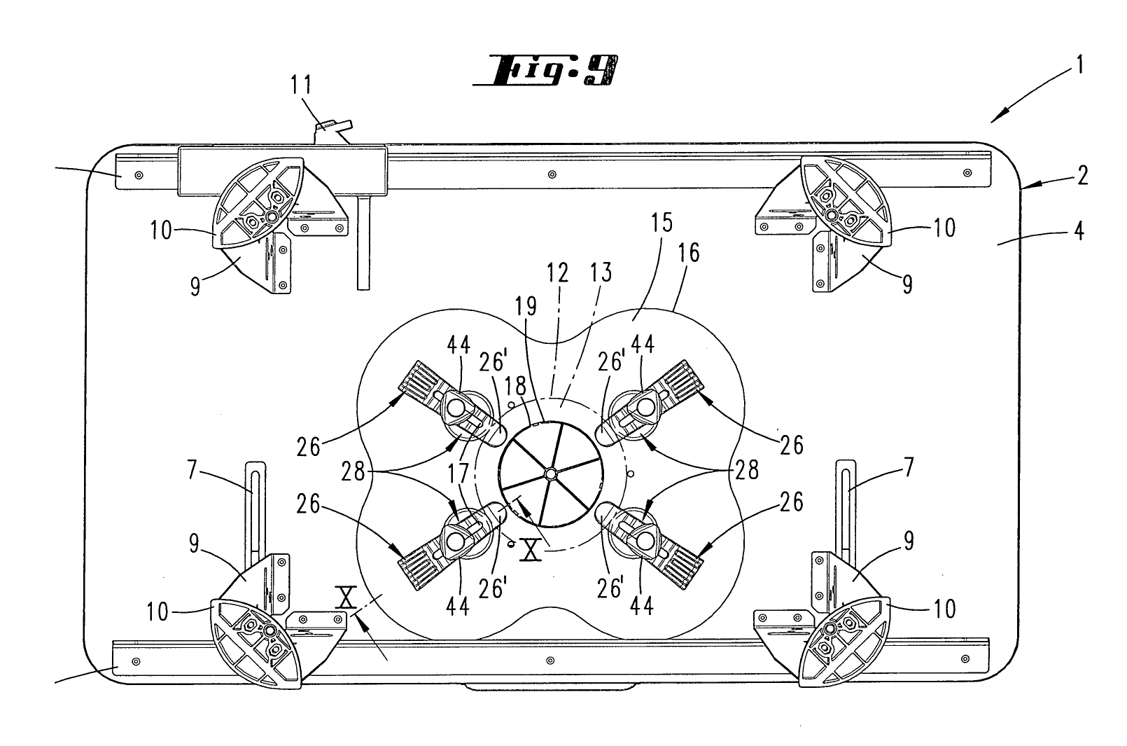

As can be gathered from FIG. 16, the clamping pins 27 project through openings 73 in the reinforcing plate 71, so that the washer which can be seen in FIG. 6 can be supported directly on the reinforcing plate. The step designated in FIG. 9 by the reference numeral 19 may be defined by the edge of the opening 72, so that the reducing component 18 can be supported on the edge of the opening 72.

All features disclosed are (in themselves) pertinent to the invention. The disclosure content of the associated/attached priority documents (copy of the prior application) is hereby also included in full in the disclosure of the application, also for the purpose of incorporating features of these documents in claims of the present application.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. A router table with a worktop which has an opening for the passage of a router bit which is drivable by a drive machine which is mountable on an underside of the worktop, a mounting flange of the drive machine being laterally fixable in position by centering elements disposed on the underside of the worktop, and being clampable against the underside by claws, which claws are in each case mounted on the worktop by a clamping pin, wherein the centering elements are centering disks with eccentric openings through which the clamping pin protrudes in each case.

2. The router table according to claim 1, wherein the centering disk is at a slight spacing from the underside.

3. The router table according to claim 1, wherein the centering disk has a circular outline.

4. The router table according to claim 1, wherein the centering disk is fixable in position by a clamping element which is formed by a nut and is associated with the clamping pin.

5. The router table according to claim 1, wherein the clamping pin, which has an external thread, protrudes through the opening in the centering disk, and the centering disk lies between two nuts, so that a lock nut effect fixes it in position.

6. The router table according to claim 1, wherein the clamping claw is a plastics part with a corrugated thrust flank and a rounded supporting shoulder with which the clamping claw is supported on a base of a depression of the worktop.

7. The router table according to claim 1, wherein retaining plates which are located in depressions on a top side of the worktop and on the back have a threaded flange, which threaded flange protrudes into a through hole, the clamping pin being screwed into the threaded flange.

8. The router table according to claim 1, wherein there is a rotationally fixed mounting of a conical end portion of the clamping pin in a countersink of the retaining plate.

9. The router table according to claim 1, wherein a clamping element is formed as a knurled or wing nut and acts, with the interposition of a thrust component, on the thrust flank of the claw.

10. A router table with a worktop and a longitudinal stop, which is disposed on the worktop and has a stop jaw carrier which is displaceable in a first horizontal direction, guided on the worktop, which stop jaw carrier has two stop jaws, which are displaceable toward each other and are clampable in displacement positions, with a T-shaped guide groove, which is aligned in a second horizontal direction, for receiving a sliding block on which a spring element, which acts perpendicularly to a plane of extent of the worktop, is mounted, wherein walls of the guide groove are formed by the stop jaw carrier and by the stop jaw.

11. The router table according to claim 10, wherein a base of the T-groove is an aligned extension of a supporting surface of the stop jaw carrier, on which supporting surface the stop jaws rest.

12. The router table according to claim 11, wherein the stop jaws are pressed against the supporting surface by means of a pull component which is actuatable from the rear side of the stop jaw carrier.

13. The router table according to claim 6, further comprising a reinforcing plate disposed on the base of the depression.

14. The router table according to claim 13, wherein the reinforcing plate which is manufactured from steel has a contour in plan view which is matched to the depression.

15. The router table according to claim 13, wherein the reinforcing plate is secured by securing tongues at an edge of the opening on the underside of the worktop.

16. A spring element for a router table according to claim 1 or 10, wherein the spring element is a peripherally continuous leaf spring.

17. The spring element according to claim 16, wherein the leaf spring has a substantially elliptical form.

18. The spring element according to claim 17, wherein a carrying element is mounted on the leaf spring and has a longitudinal slot which extends parallel to a small semiaxis of the ellipse.

19. A spring element according to claim 18, wherein the carrying element is disposed substantially in the center of the elliptical spring.

20. The spring element according to claim 18, wherein the carrying element and the spring are formed as a unitary component from a plastics part.

21. The spring element according to claim 17, further comprising a step, which is provided in the region of narrow ends of the elliptical spring, with a thrust surface running parallel to the large semiaxis.

22. The spring element according to claim 21, wherein the step is formed by a kink in the spring.

23. The spring element according to claim 21, wherein the step is formed by a hump.

24. The spring element according to claim 16, wherein the spring element has a T-shape, the T-cross piece being formed by a carrying element and the T-leg being formed by the leaf spring.

25. The spring element according to claim 17, wherein the large semiaxis of the ellipse is at least twice the length of the small semiaxis.
